(19) United States
(12) Patent Application Publication
(10) Pub. No.: US 2008/0177571 A1
(43) Pub. Date: Jul. 24, 2008

(54) SYSTEM AND METHOD FOR PUBLIC HEALTH SURVEILLANCE AND RESPONSE

(76) Inventors: James H. Rooney, Harvard, MA (US); James C. Stamm, Richardson, TX (US); Gurpartap S. Takhar, N. Attleboro, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/870,582

(22) Filed: Oct. 11, 2007

Related U.S. Application Data
(60) Provisional application No. 60/829,571, filed on Oct. 16, 2006.

(51) Int. Cl. G06Q 50/00

(52) U.S. Cl. 705/2

(57) ABSTRACT

A system and method for public health surveillance and response employ at least one processing center configured to receive medical data and to process the medical data to generate processed medical data indicative of a medical event. The method and system can provide to a subscriber of the system and method at least one of an alert message indicative of the medical event or medical data associated with the processed medical data.

### CROSS REFERENCE TO RELATED APPLICATIONS

This application claims the benefit under 35 U.S.C. § 119(e) of U.S. Provisional Application No. 60/829,571 filed Oct. 16, 2006, which application is incorporated herein by reference in its entirety.

### FIELD OF THE INVENTION

This invention relates generally to systems and methods for detecting events occurring in the environment and, more particularly, to a system and method for detecting and communicating an occurrence of a medical event and for determining and coordinating an associated response.

### BACKGROUND OF THE INVENTION

Disease surveillance for epidemic intelligence purposes at the national and international level can provide critical information for early detection and containment of emerging health threats. Local, regional, national, and international disease surveillance systems have evolved in the absence of international standards or collaborative protocols for specific data types, resulting in a wide variety of heterogeneous databases, each containing valuable information. Current information sharing across the various reporting systems (human, veterinary and agriculture) happens via human-intensive, time-consuming activities such as the exchange of emails or faxes.

Currently, disease and medical event reporting occurs in various forms for humans, domestic and wild animals, and agriculture according to heterogeneous networks set up within countries by the agencies responsible for tracking the information. The existing heterogeneous networks are effective in their prescribed applications; however, are limited in global effectiveness because they are; not real time, stove piped, stand alone, platform-centric, difficult to search, and often proprietary. To achieve timely and effective global disease surveillance requires the aggregation and integration of data from many heterogeneous sources.

For example some forms of the influenza virus have infected and killed very large numbers of people over very large geographic regions in a single globally spread “medical event,” which includes a plurality of incidents of the infectious disease. The influenza virus is known to mutate from time to time, generating new strains of the virus. Some strains are known to start in animals, some of which can also infect humans. For example, the so-called “avian flu” virus, which started in birds, is able to infect humans.

In general, it is difficult to track the locations and spread of an infectious disease, locally, regionally, and worldwide. Medical records exist in different languages, formats, and databases in different parts of the world. Furthermore, different privacy laws particular to different countries or regions can impede communication of an occurrence of a medical event beyond the country or region boundaries or even within the country or region. Without at least regional knowledge of the spread of a medical event, it is difficult to execute a proper response to mitigate the spread and affect of the disease.

Furthermore, intentional or unintentional release of chemical agents, biological agents, radiological agents, or nuclear agents can generate an “environmental event” that can pose a threat to human populations. Also, intentional or unintentional explosions are known to cause another type of environmental event.

The above-identified agents and explosions can also pose a threat due to accidents, such as industrial accidents or natural disasters. For example, a large accidental chemical release in Bhopal, India in 1984 at a Union Carbide chemical plant killed as many as four thousand people. Industrial explosions are also known to occur.

Even if a medical event or an environmental event were detected, there is presently little ability to rapidly coordinate a response among many types of responders. Responders can include people from a variety of public and governmental organizations. For example, responders can include, but are not limited to, police, fire departments, civil defense, national guard, military, centers for disease control, disaster relief agencies, Red Cross, emergency medical technicians, hospitals, transportation modes, local government officials, state government officials, federal government officials, the World Heath Organization, and the Center for Disease Control.

Proper coordination of the many types of responders requires a variety of types of information, some of which are not readily available upon first detection of a medical event or an environmental event. For example, types of information associated with an event include, but are not limited to, the type of event, the location(s) of the event, the geographic extent of the event, event correlation with other events, an acceptable response, the type of help needed, e.g., what agencies or departments and the quantity of help needed.

Often, the speed of response to a medical event or to an environmental event is crucial in order to reduce harm to people, property, and the economy. However, the above-described types of information are often determined and/or acquired over a period of time by one or more people organizations or systems, limiting the speed of the response to the event.

### SUMMARY OF THE INVENTION

A system includes a first processing center coupled to receive first medical data in a first format. The first processing center includes a computer processor configured to process the first medical data to generate first processed medical data indicative of a medical event, configured to generate an alert message in accordance with the medical event, and configured to communicate to an information destination at least one of the alert message or second medical data in a second format indicative of at least a portion of the first processed medical data.

A computer-implemented method of coordinating medical data includes receiving first medical data in a first format at a first processing center and processing the first medical data at the first processing center in order to generate first processed medical data indicative of a medical event. The method further includes generating an alert message in accordance with the medical event and communicating to an information destination at least one of the alert message or second medical data in a second format indicative of at least a portion of the first processed medical data.

### BRIEF DESCRIPTION OF THE DRAWINGS

The foregoing features of the invention, as well as the invention itself may be more fully understood from the following detailed description of the drawings, in which:

FIG. 1 is a block diagram showing a simplified system for public health surveillance and response having a data acquisition point, a point of presence, a network operation center, and a subscriber;

FIGS. 2 and 2A are block diagrams showing types of medical data that can exist in, and that can be communicated by, the data acquisition point, the point of presence, and the network operation center of FIG. 1;

FIG. 3 is a block diagram showing a system for public health surveillance and response having one or more data acquisition points (DAPs); one or more in-country points of presence (POPs), and a network operation center (NOC);

FIG. 4 is a block diagram showing further details of the DAPs, POPs, and NOC used in the system of FIG. 3;

FIGS. 5 and 5A are a flow chart showing a method of operation of the system for public health surveillance and response of FIG. 3;

FIG. 6 is another block diagram of the system for public health surveillance and response as in FIG. 3, having a satellite communication structure; and

FIG. 7 is a block diagram showing another system for public health surveillance and response, including aspects of the system for public health surveillance and response of FIG. 3 and including environmental event sensors.

### DETAILED DESCRIPTION OF THE INVENTION

Before describing the present invention, some introductory concepts and terminology are explained. As used herein, the term “medical event” is used to describe an infectious disease outbreak of one or more “incidents” of an infectious disease among a population of people, animals, or crops/vegetation that occurs over a substantial population of people, animals, or crops/vegetation, which can be over a substantial geographic region. For example, a medical event can be spread across one or more towns, cites, counties, province, or countries. A medical event can be, but is not limited to, a so-called “pandemic.” The World Heath Organization has quantified a so-called “pandemic” to be a disease outbreak that causes at least three cases having severe respiratory symptoms, identified within a ten-day period over a predetermined geographic area.

As used herein, the term “environmental event” is used to describe an event that occurs in the environment, for example, a release of a biological agent (a “biological event”), release of a chemical agent (a “chemical event”), release of a radiological agent (a “radiological event”), release of a nuclear agent (a “nuclear event”), detection of an explosive agent (an “explosive event”), as well as an detection of an explosion (an “explosion event”), for example, a bomb, an industrial explosion, or a gun shot. Furthermore, as used herein, an “environmental event” can also be naturally occurring, for example, an earthquake.

As used herein, the term “real-time” is used to describe computer operations that are performed without appreciable delay, for example, at the speed of the computer processing, or at the speed of computer communications. It should be appreciated that the systems and methods described herein can operate in real-time, so that a medical event or an environmental event can result in real-time instructions to responders. However, in other embodiments, there can be any time delay in any part of the systems and method described herein.

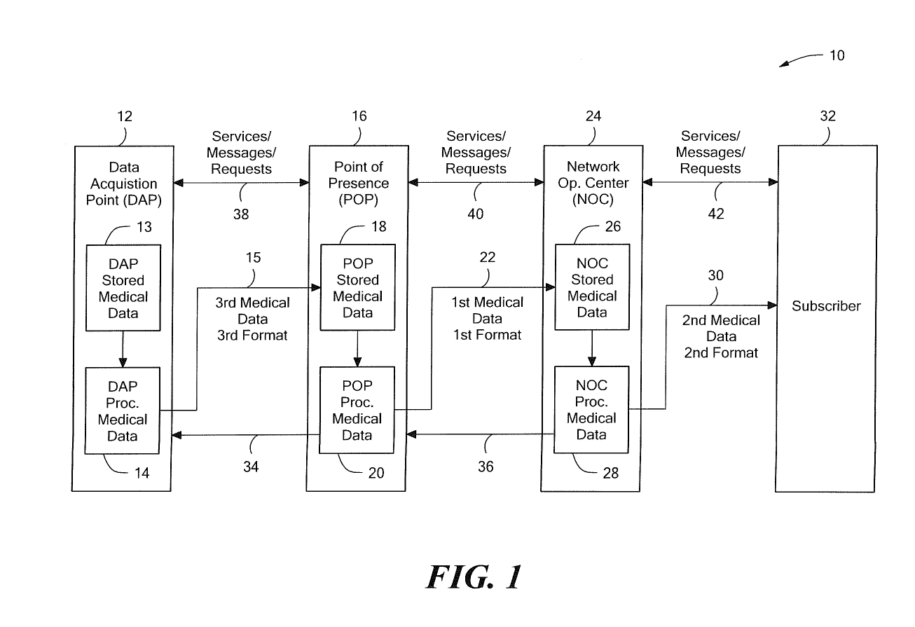

Referring to FIG. 1, an exemplary system 10 for public health surveillance and response includes at least one data acquisition point 12 coupled to at least one point of presence (POP) 16, which is coupled to at least one network operation center (NOC) 24. The NOC 24 is coupled to at least one subscriber 32 to the system 10.

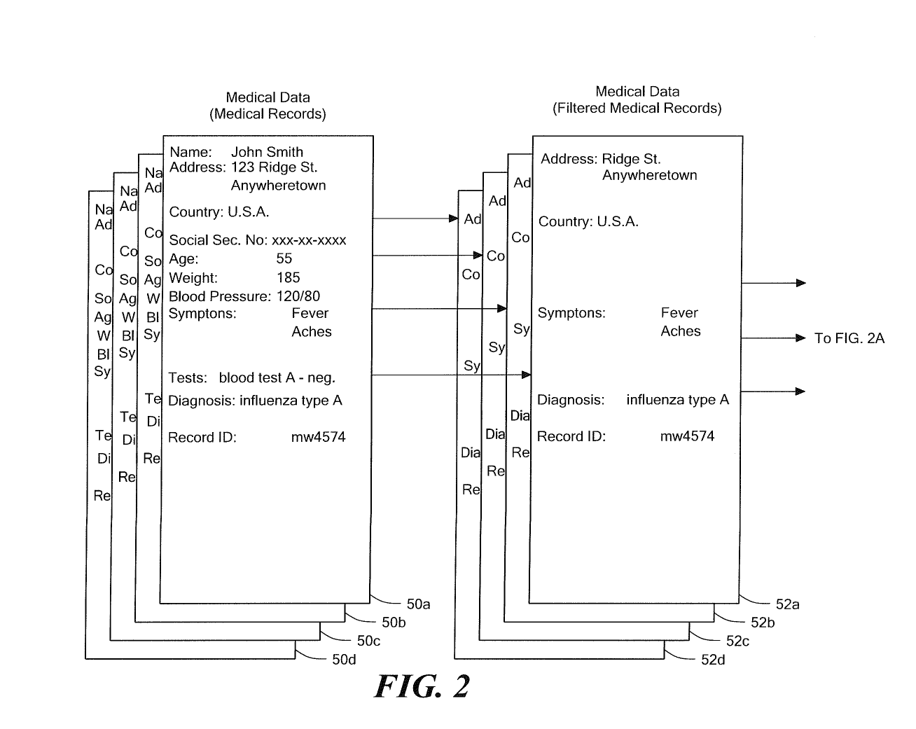

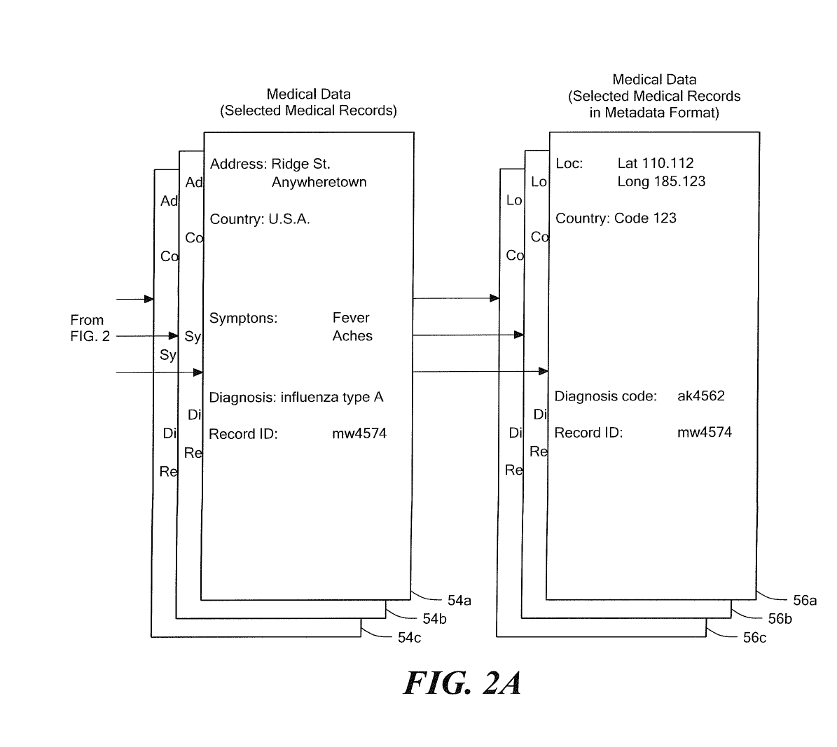

Medical data having a variety of types and formats is described in conjunction with FIG. 1. Exemplary medical data types and format are described more fully below in conjunction with FIGS. 2 and 2A.

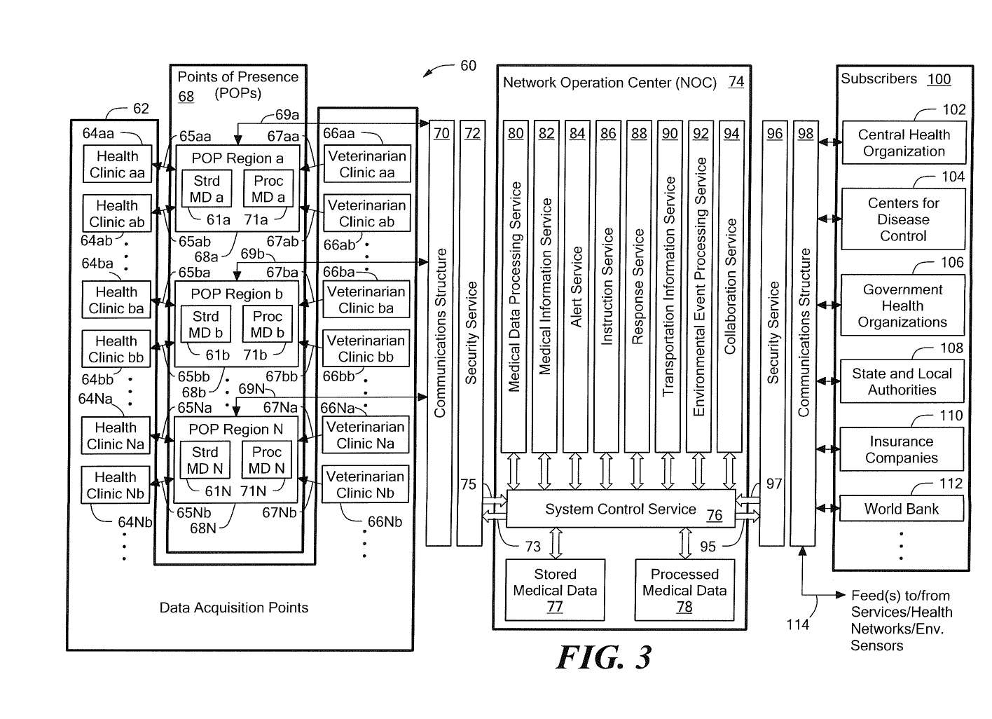

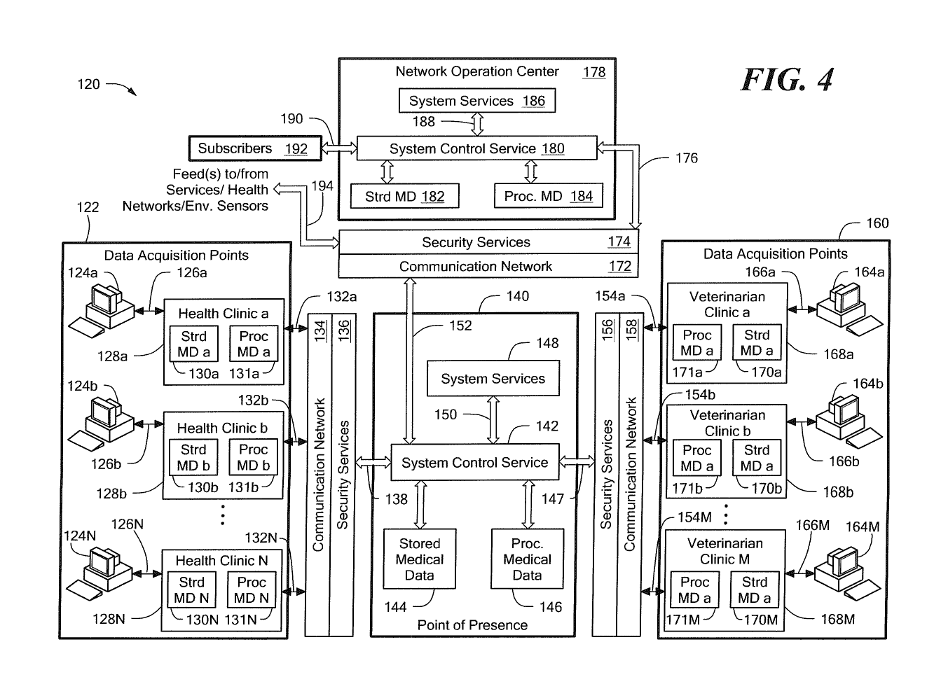

The DAP 12 is coupled to receive and store DAP stored medical data 13. The DAP 12 is configured to process the DAP stored medical data 13 to generate DAP processed medical data 14. Various processors are shown below in conjunction with FIGS. 3 and 4, but are not shown in FIG. 1 for clarity. The DAP 12 is coupled to communicate the DAP medical data 15 in a DAP medical data format to the POP 16. The POP 16 is configured to store the DAP medical data 15 as POP stored medical 18. The POP 16 is also configured to process the POP stored medical data 18 to generate POP processed medical data 20 indicative of incidents of infectious diseases (and potentially indicative of a medical event) and, in some arrangements, to generate an alert message in accordance with a detected medical event. The POP 16 is coupled to communicate at least one of POP medical data 22 in a POP medical data format to the NOC 24 or an alert message 40 to the NOC 24.

Similarly, the NOC 24 is configured to store the POP medical data 22 as NOC stored medical data 26. The NOC is also configured to process the NOC stored medical data 26 to generate NOC processed medical data 28 associated with a detected medical event and to generate an alert message in accordance with the medical event. The NOC 24 is coupled to communicate at least one of NOC medical data 30 in a NOC medical data format to the subscriber 32 or an alert message 42 to the subscriber 32.

The DAP 12, the POP 16, the NOC 24, and the subscriber 32 can receive respective services and messages and can make requests 38, 40, 42 described more fully below. In particular, one type of message 38, 40, 42 is the above-described alert message.

The NOC 24 can also be coupled to communicate certain medical data 36 described more fully below back to the POP 16. Similarly, the POP 16 can be coupled to communicate certain medical data 34 described more fully below back to the DAP 12. It should be recognized that the communication of medical data in two directions can lead to a transparent system in which the DAP 12, the POP 16, and the NOC, can each have the same or similar information.

The DAP medical data 15, the POP medical data 22, 34 and the NOC medical data 30, 36 can be different types of medical data or the same types of medical data. Furthermore, the formats of the different medical data can be different or the same. Medical data and medical data formats are described more fully below in conjunction with FIGS. 2 and 2A.

It will become apparent fi-om discussion below, that in some arrangements, the system can include more than one DAP 12, more than one POP 16, more than one NOC 24, and more than one subscriber 32. It will also become apparent from the discussion below in conjunction with FIG. 3 that the NOC 24 can couple to existing healthcare networks and/or to other existing relevant databases.

In some arrangements, each POP 16 is associated with a country or region and the NOC 24 is associated with a region larger than a country or with the entire world. For systems in which there is more than one POP 16, the NOC 24 can receive the POP medical data 22 from more than one POP. The POP medical data received from any one POP can be indicative of occurrences of an infectious disease, but may or may not be indicative of a medical event. The POP medical data 22 received from more than one POP (and also, in some embodiments, heterogeneous healthcare data received from more than one healthcare network described below in conjunction with FIG. 4) can be further processed by the NOC 24 to identify a medical event beyond a country or regional scope to which any one NOC has visibility.

In some arrangements, one or more of the stored medical data 13,18, 26 is not provided and the processed medical data 20, 28 is generated in real-time by processing the DAP medical data 15 and POP medical data 22, respectively.

Referring now to FIGS. 2 and 2A, different types of medical data and different medical data formats are shown. It should be understood that any of the medical data types and formats shown in FIGS. 2 and 2A can be representative of any of the medical data and medical data formats 13, 14, 15, 18, 20, 22, 26, 28, 30, 34, 36 of FIG. 1. However, an exemplary arrangement is described more fully below. Furthermore, it should be understood that all of the medical data and medical data formats of FIGS. 2 and 2A are exemplary and are not intended to represent the only medical data or medical data formats that can be used with this system or method.

Medical records 50a-50d are representative of medical data that may be entered into the data acquisition point 12 of FIG. 1, for example, by an operator, and stored as the DAP stored medical data 13 of FIG. 1. It should be recognized that the medical records 50a-50d can have personal information about respective patients, including, but not limited to, a name, an address, a social security number, an age, and a weight. The medical records 50a-50d can also each include a respective listing of symptoms, tests that were run on the patient, a diagnosis, and a record identifier (ID). Each one of the medical records 50a-50d can pertain to the same person or each one of the medical records can pertain to different people.

The medical records 50a-50d include respective diagnoses, any one of which may or may not be indicative of an infectious disease (and which may or may not be a part of a medical event). Therefore, only some of the medical records 50a-50d may be of interest toward identification of a medical event. For illustrative purposes, it will be assumed that only the three medical records 50a-50c include respective diagnoses of an infectious disease, which may or may not be the same infectious disease.

The medical records 50a-50d can include a particular set of medical data and can have a particular medical data format as shown. It should be appreciated that the medical records 50a-50d include personal information that may be restricted from distribution according to national or regional privacy laws.

A set of so-called “filtered” medical records 52a-52d are related to the medical records 50a-50d, however, the medical records 52a-52d have been filtered in at least one regard. In this regard, the filtered medical records 52a-52d do not include personal information that could readily identify the people to whom the medical data of the filtered medical records 52a-52d pertain. In other words, the medical records 50a-50d have been filtered to remove the personal information, resulting in the filtered medical records 52a-52d.

Like the medical records 50a-50d, the filtered medical records 52a-52d include respective diagnoses, any one of which may or may not be indicative of an infectious disease (and which may or may not be a part of a medical event). Therefore, only some of the filtered medical records 52a-52d may be of interest toward identification of a medical event. For illustrative purposes, it will be assumed that only the three filtered medical records 52a-52c include respective diagnoses of an infectious disease, which may or may not be the same infectious disease, and which may or may not be a part of a medical event.

Referring now to FIG. 2A, so-called “selected medical records” 54a-54c, which can be the same as or similar to the filtered medical records 52a-52c of FIG. 2, can be selected by processing the filtered medical records 52a-52d of FIG. 2 (or alternatively, by processing the medical records 50a-50d of FIG. 2). The selected medical records 54a-54c each have respective diagnoses indicative of an infectious disease, which may or may not be the same infectious disease, and which may or may not be part of a medical event. The filtered medical record 52d was essentially eliminated from further consideration by the processing, since it was not indicative of an infectious disease of interest (or medical event).

So-called “metadata” 56a-56c corresponds to the selected medical records 54a-54c, but in a metadata format. Therefore, the metadata is also referred to herein as selected medical data.

It should be understood that the metadata is related to the filtered medical records 52a-52c, and therefore, to the medical records 50a-50c. The format of the metadata 56a-56c is substantially or entirely encoded in order to provide still further security against release of personal information contained in the medical records 50a-50c. Furthermore, the location of the occurrence of the infectious disease in the metadata 56a-56c can be converted to latitudes and longitudes, which may be of more interest when attempting to identify an infectious disease or medical event and the spread of the infectious disease or medical event.

Like the selected medical records 54a-54c, each record within the metadata 56a-56c is indicative of an infectious disease, which may or may not be the same infectious disease. The metadata 56a-56c may or may not be indicative of a medical event. A subset of the metadata 56a-56c (or of the selected medical records 54a-54c) may be indicative of a medical event.

The metadata 56a-56c can include the record identifiers common to all of the types of medical data. With the record identifier, if desired, the metadata 56a-56c can be backtracked all the way back to the medical records 50a-50c of FIG. 2.

Referring to both FIGS. 2 and 2A and also to FIG. 1, in some arrangements, the medical records 50a-50d can be representative of medical data that may be entered in and exist in the data acquisition point 12 of FIG. 1 as the DAP stored medical data 13, the filtered medical records 52a-52c may be representative of the DAP processed medical data 14, and of the DAP medical data 15 communicated from the DAP 12 to the POP 16, and also of the POP stored medical data 18 within the POP 16. The metadata 56a-56c may be representative of the POP processed medical data 20 within the POP 16, the POP medical data 22 communicated from the POP 16 to the NOC 24, and also may be representative of the NOC stored medical data 26. All or a subset of the metadata 56a-56c, in particular, metadata that is indicative of a medical event, may be representative of the NOC processed medical data 28.

The NOC medical data 30 in the NOC medical data format communicated from the NOC 24 to the subscriber 32 can be in a variety of formats, for example, a format not shown in FIGS. 2 and 2A. In one particular embodiment, the NOC medical data 30 communicated to the subscriber 32 is in the form of reports and statistics. For example, the reports and statistics can include, but are not limited to disease type and occurrence and also death rates. However, in other embodiments, all or a subset of the metadata 56a-56c of FIG. 2A may be representative of the NOC medical data 30 communicated to the subscribers 32.

In some arrangements, record IDs (see, e.g., FIG. 2A), which are indicative of a medical event, may be representative of the medical data 36 communicated from the NOC 24 to the POP 16, and also may be representative of the medical data 34 communicated from the POP 16 to the DAP 12. As described above, the record IDs can be used to identify medical records associated with the record IDs, the medical records being in any of the medical data formats of FIGS. 2 and 2A.

In some other arrangements, the medical data 36 communicated from the NOC 24 to the POP 16 can include some or all of the NOC processed medical data 28 (e.g., metadata) associated with a medical event, and/or the medical data 34 communicated from the POP 16 to the DAP 12 can include some or all of the POP processed medical data 20 (e.g., metadata) associated with a medical event.

Referring to FIG. 3, an exemplary system 60 for public health surveillance and response includes at least one point of presence (POP), here POPs 68a-68N are shown. The POPs 68a-68N are coupled to receive respective medical data 65aa, 65ab, 65ba, 65bb, 65Na, 65Nb provided by one or more health clinics 64aa, 64ab, 64ba, 64bb, 64Na, 64Nb. In some embodiments, the POPs 68a-68N are also coupled to receive respective medical data 67aa, 67ab, 67ba, 67bb, 67Na, 67Nb provided by one or more veterinarian clinics 66aa, 66ab, 66ba, 66bb, 66Na, 66Nb. The medical data 65aa, 65ab, 65ba, 65bb, 65Na, 65Nb, 67aa, 67ab, 67ba, 67bb, 67Na, 67Nb can any of the types and formats of medical data shown in FIGS. 2 and 2A. However, in some embodiments, the filtered medical records 52a-52d of FIG. 2 are representative of the medical data 65aa, 65ab, 65ba, 65bb, 65Na, 65Nb, 67aa, 67ab, 67ba, 67bb, 67Na, 67Nb communicated to the POPs 68.

It will be recognized that the health clinics 64aa, 64ab, 64ba, 64bb, 64Na, 64Nb and the veterinarian clinics 66aa, 66ab, 66ba, 66bb, 66Na, 66Nb per-se (and the existing heterogeneous healthcare networks and relevant databases described below in conjunction with FIG. 4) are not part of the present invention. However, the system 60 can include data entry points, e.g., terminals (not shown), within the health clinics 64aa, 64ab, 64ba, 64bb, 64Na, 64Nb and/or within the veterinarian clinics 66aa, 66ab, 66ba, 66bb, 66Na, 66Nb (and within the existing heterogeneous healthcare networks and relevant databases described below in conjunction with FIG. 4), which are used by doctors or staff to enter the medical records, for example, the medical records 50a-50d described above in conjunction with FIG. 2, which can include, but are not limited to, information pertaining to incidents of infectious diseases.

The health clinics and veterinarian clinics can be distributed over any geographic region(s). However, for illustrative purposes, in the discussion below, the health clinics 64aa, 64ab, the veterinarian clinics 66aa, 66ab, and the POP 68a are in a first country, the health clinics 64ba, 64bb, the veterinarian clinics 66ba, 66bb, and the POP 68b are in a second country, and the health clinics 64Na, 64Nb, the veterinarian clinics 66Na, 66Nb, and the POP 68N are in an N-th country. It should be recognized that there can be more than or fewer than those POPs, health clinics, and veterinarian clinics shown, including more than one POP in a country.

Taking the health clinics 64aa, 64ba and veterinarian clinics 66aa, 66ba as representative of other ones of the health and veterinarian clinics, and the POP 68a as representative of other ones of the POPs, the POP 68a receives medical data 65aa 65ab, 67aa, 67ab (which can, for example, be in the form of the filtered medical records 52a-52c of FIG. 2) when medical data (which can, for example, be in the form of the medical records 50a-50c of FIG. 2) is entered by doctors or staff people. In some embodiments, medical data can be entered by a doctor or staff person at the health and veterinarian clinics 64aa, 64ab, 66aa, 66ab in pre-structured computer forms presented by the system 60. In other embodiments, the data entry can be free form, and the system 60 can be configured to recognize key words.

The medical data 65aa 65ab, 67aa, 67ab may or may not be indicative of one or more incidents of an infectious disease, and may or may not be indicative of a medical event. The POP 68a can store the medical data 65aa 65ab, 67aa, 67ab as POP stored medical data 61a and can process the POP stored medical data 61a to generate POP processed medical data 71a of interest. In some embodiments, the POP processed medical data 71a includes only medical data indicative of one or more infectious diseases and can be in the form of the metadata 56a-56c of FIG. 2A.

In some arrangements, the POP 68a can identify a geographically local medical event, i.e., a medical event within a region supported by the POP 68a and by the clinics 64aa, 64ab, 66aa, 66ab. To this end, the POP 68a can perform a correlation of the POP processed medical data 71a, or, more generally, a correlation of the medical data 65aa, 65ab, 67aa, 67ab, in order to identify the medical event.

As described above, the World Heath Organization has quantified a so-called “pandemic” to be a disease outbreak that causes at lease three cases having severe respiratory symptoms, identified within a ten-day period over a predetermined geographic area. Therefore, for example, if the POP 68a identifies that a diagnosis of the same respiratory disease has been received at least three times, by any combination of one or more clinics to which it is coupled, within the predetermined area and within ten days, the POP 68a can identify a pandemic. However, other criteria can also be used to identify an important medical event.

In some embodiments, the POP 68a can process and correlate the POP stored medical data 61a or the POP processed medical data 71a (or, more generally, the medical data 65aa, 65ab, 67aa, 67ab). As described above, the POP processed medical data 71a can be all metadata (e.g., 56a-56c of FIG. 2A). Thus, the POP 68a can perform two processing steps; a first step to convert the POP stored medical data 61a (e.g., filtered medical records 52a-52d of FIG. 2) to the POP processed medical data 71a (e.g., metadata 56a-56c of FIG. 2A), and a second step to process the POP processed medical data 71a to identify a medical event according to criteria, of which the above-described pandemic criteria is but one example.

The POP 68a is configured to communicate a message 69a, which can include at least a portion of the POP processed medical data 71a via a communication structure 70. Similarly, other ones of the POPs 68b-68N are configured to communicate respective messages 69b-69N, which can include at least respective portions of other POP processed medical data 71b-71N via the communication structure 70. In arrangement for which the POPs 68 perform the above-described correlation in order to identify a medical event from within the POP processed medical data 71a-71N, and in which a medical event is actually identified by a POP, one or more of the messages 69a-69N generated by the POPs 68 can also include a so-called “alert message” indicative of the medical event.

In some particular arrangements, the communications structure 70 includes the Internet, either wired or wireless. In other particular arrangements, the communication structure 70 includes the SIPRNET, which is a known secure military communication structure.

A security service 72 can be associated with the communications structure 70. For example, the security services can include, but are not limited to, secure http protocol (https), Internet protocol security (IPSec), and virtual private network (VPN).

As used herein, the term “service” when referring to software can be a software agent, running together with other software agents in a common computing platform. However, in other arrangements, a software “service” can be a software application running on a computing platform remote from other computing platforms, which communicate with the software service. The various computing platforms can be coupled in a variety of ways, including, but not limited to, the Internet and the SIPRNET.

The system 60 can also include a network operation center (NOC) 74 coupled to receive the messages 69a-69N (i.e., a message 75) generated by the POPs 68, after having passed through the communications structure 70 and the security service 72. It will, however, become more apparent from discussion below that the POPs 68 can communicate messages not only to the NOC 74, but also back to the DAPs 62 to which they are coupled.

The NOC 74 can include system control services 76, configured to control other elements of the NOC 74. The NOC 74 can also include a medical data processing service 80, a medical information service 82, an alert service 84, an instruction service 86, a response service 88, a transportation information service 90, an environmental event processing service 92, and a collaboration service 94, each coupled to the system control service 76. The NOC 74 can also include NOC stored medical data 77 and NOC processed medical data 78 coupled to the system control service 76. The NOC stored medical data 77 can be representative of medical data within the messages 69a-69N (i.e., within messages 75) received from the POPs 68.

The medical data processing service 80 is configured to process the NOC stored medical data 77, i.e., the medical data within the messages 75 received from at least one, but preferably from a plurality of POPs (e.g., 68a-68N), in order to generate the NOC processed medical data 78. The NOC processed medical data 78 can be in the form of metadata 56a-56c (FIG. 2A). The NOC processed medical data 78 can be, for example, a subset of the NOC stored medical data 77. For example, all of the metadata 56a-56c can be representative of the NOC stored medical data 77 and only portions of the metadata 56a-56c that are indicative of a medical event can be representative of the NOC processed medical data 78.

To this end, in some embodiments, the medical data processing service 80 is further configured to process and correlate the NOC stored medical data 77 in order to identify a medical event that may have occurred in one or more regions associated with the one or more POPs 68. Accordingly, the medical data processing service 80 can identify a subset of the NOC stored medical data 77 to generate the NOC processed medical data 78, which is indicative of one or more medical events.

In some arrangements, the medical data processing service 80 can also generate a geographical map of an extent of, or infection occurrences of, the medical event. It will be recognized that the map can provide a view of time spread of the disease. In some embodiments, the medical data processing service 80 can identify more than one disease that has broken out in one or more regions associated with the one or more POPs 68 and can generate separate maps of extents of, or infection occurrences of, separate medical events.

In some embodiments, the medical data processing service 80 can generate a variety of other processing results including, but not limited to, identification of a potential means by which the disease is spreading (e.g., aircraft), a potential time for the disease to arrive at other geographic regions where it is presently not found, and identification of potential geographic quarantine boundaries.

The medical information service 82 is configured to collect, either continually, or from time to time, “medical information” associated with one or more infectious diseases. For example, the medical information service 82 can collect treatment information, length of recovery information, and degree of contagiousness information associated with a medical event detected by the medical data processing service 80, or alternatively, associated with a plurality of diseases in general.

The alert service 84 is configured to generate an alert message in response to detection of a medical event by the medical data processing service 80. The alert message can be a simple alert message, providing notification of the medical event.

The alert message (and the processing used to generate the NOC processed medical data 78 indicative of a medical event) can be based upon a variety of thresholds or criteria. For example, in some embodiments, the thresholds can be identified in accordance with the above-described definition of a pandemic. The thresholds can include, but are not limited to, combinations of a geographic area threshold, a number of occurrences per time threshold, a number of occurrence threshold, or a type of disease threshold.

The instruction service 86 is configured to generate one or more instruction messages, including, but not limited to, an instruction message to stop travel to and from regions having a medical event, and locations of vaccine stockpiles.

The instruction service 86 can also identify so-called “cluster areas,” which are geographical regions, or facilities within geographic regions, to which the instructions pertain. The cluster areas can include regions associated with one or more of the POPs 68, to which relevant instructions can be sent. However, the cluster areas can include other facilities, for example hospitals that do not serve as POPs.

The response service 88 can receive “response information” from responders and can dynamically generate response instructions via the instruction service 86 to coordinate an ongoing response by the cluster areas, by subscribers 100, and/or other organizations.

The transportation information service 90 can receive transportation information 114 and provide the transportation information to the other services. The transportation information can include, but is not limited to, train and airplane schedules and destinations. The transportation information service 90 can coordinate with the medical data processing service 80, transportation information pertaining to geographic regions having a medical event identified by the medical data processing service 80. The transportation service 90 can also provide the transportation information to the instruction service 86, so that the instruction service 86 can, for example, generate instructions to restrict travel to a region having a medical event.

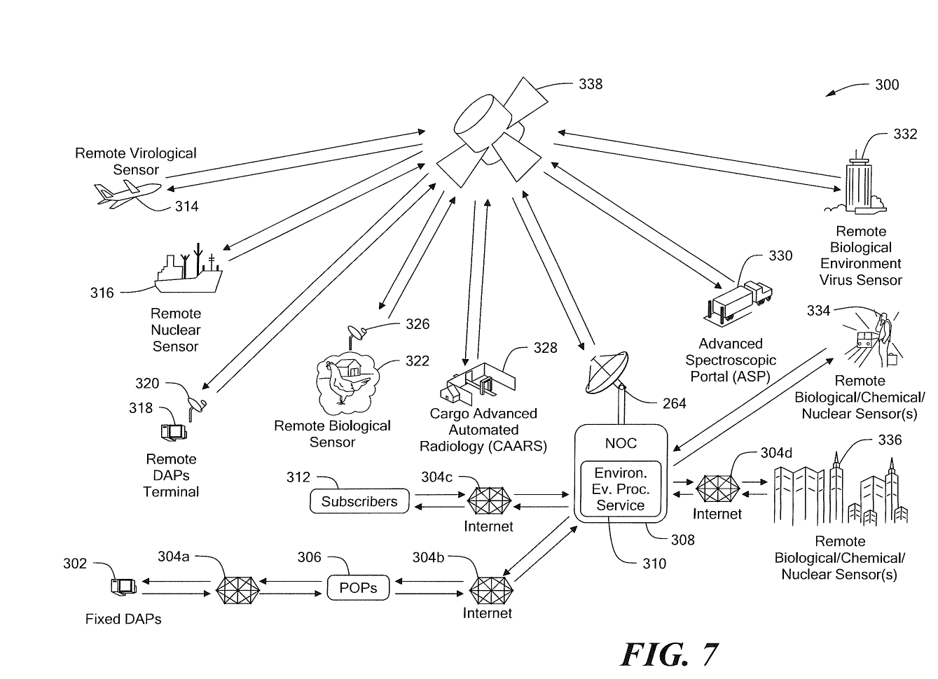

The environmental event processing service 92 can receive event sensor signals 114 (described more fully below in conjunction with FIG. 7), process the event sensor signals 114 to detect an environmental event, and provide information to the other services pertaining to the detected environmental event.

The collaboration service 94 can receive information 114 from one or more of the heterogeneous healthcare networks, for example, PoMed, Global Outbreak Alert and Response Network, and Global Early Warning System and Response, providing a global situational awareness. However, it should be also understood that information 114 received from the heterogeneous healthcare networks may not be sufficiently new to be used toward the real-time identification of a medical event. Nevertheless, the collaboration service 94 can provide data exchange, aggregation, and integration of the information received from the heterogeneous health networks, enabling global disease surveillance without the need for expensive harmonization of data across the various systems.

The information 114 can be received not only from healthcare networks (e.g., the examples provided above), but also from regional health information organizations (RHIOs). RHIOs will be understood to be particular types of health information exchanges (HIEs). A health information exchange (HIE) is an electronic exchange of healthcare information across organizations within a region or community. An HIE provides the capability to electronically move some types of medical information between disparate healthcare information systems while maintaining the meaning of the information being exchanged. An HIE facilitates access to and retrieval of clinical data to provide safer, more timely, efficient, effective, and equitable patient-centered care. HIEs also provide an infrastructure for secondary use of clinical data for purposes such as public health, clinical, biomedical, and consumer health informatics research as well as institution and provider quality assessment and improvement.

RHIOs are important to the United States National Health Information Network (NHIN). RHIOs are multistakeholder organizations expected to be responsible for motivating and causing integration and information exchange within the United States healthcare system. In general, stakeholders develop an RHIO to effect the safety, quality, and efficiency of healthcare as well as to improve access to healthcare as the result of health information technology. Regions in the United States continue to use various definitions of “multistakeholder organizations.” For instance, in Wichita, Kans., the so-called Clinics Patient Index is a software architecture as well as a support environment in an RHIO that facilitates integration among outpatient clinics and hospital emergency departments. Other RHIOs are forming between multiple hospitals, while still others might include medical societies, payers, and major employers.

In some arrangements, medical information 114 received from one or more health networks and/or from one or more RHIOs can also be used by the medical data processing service 80. For example, the medical data processing service 80 can also be configured to process and correlate the NOC stored medical data 77 with the medical information 114 in order to identify a medical event that may have occurred in one or more regions associated with the one or more POPs 68. Accordingly, as described above, the medical data processing service 80 can identify a subset of the NOC stored medical data 77 to generate the NOC processed medical data 78, which is indicative of one or more medical events. However, it should also be recognized that the medical data 114 received from the one or more health networks and/or from the one or more RHIOs can be older data that is not useful to identify a medical event. Nevertheless, the medical data 114 or parts of the medical data 114 can be included in reports sent to the subscribers 100 described more fully below.

The NOC 74 is configured to communicate messages 95 to subscribers 100, or messages 73 to selected ones of the POPs 68, or to both. The messages 73, 95 can include one or more of a portion of the NOC processed medical data 78 (e.g., record IDs associated with a medical event), the above-described alert message generated by the alert service 84, the above-described medical information generated by the medical information service 82, the above-described instruction messages generated by the instruction service 86, the above-described response instructions received by the response service 88, the above-described transportation information generated by the transportation information service 90, the above-described environmental event detected by the environmental event processing service 92, or the above-described information from health networks provided by the collaboration service 94. In some arrangements, the messages 73, 95 sent to the selected POPs 68 and to the subscribers 100 are the same messages. In other arrangements, the messages 73, 95 are different messages tailored to the particular selected POPs 68 and to the particular selected subscribers 100 to which the different messages are sent. In some arrangements, while the record IDs associated with a medical event constitute the portion of the NOC processed medical data 78 communicated in the messages 73, the messages 95 sent to the subscribers 100 can instead include other types of medical information, for example, the above-described reports and statistics.

It should be recognized that it is desirable that the NOC processed medical data 78 contain only information that is necessary for detecting and monitoring the outbreak of one or more medical events. Therefore, in some embodiments, as described above, the NOC processed medical data 78 does not contain all of the medical data 75 received by the NOC 74 and stored as the NOC stored medical data 77.

The NOC processed medical data 78 can be sorted according to predetermined rules. For example, subscribers 100 can subscribe to receive particular reports and statistics associated with the NOC processed medical data 78, for example, reports and statistics that pertain only to their geographic region. Therefore, a government organization, for example, the French government, can subscribe to receive only information that pertains to France. Subscribers 100 can also subscribe to receive only certain types of the above-described messages within the messages 95 communicated by the NOC 74.

Subscribers 100, which can subscribe to the system 60, can include, but are not limited to, a central health organization (e.g., the world health organization (WHO)) 102, centers of disease control (CDCs) 104, other government health organizations 106, state and/or local authorities 108, insurance companies 110, or the world bank 112.

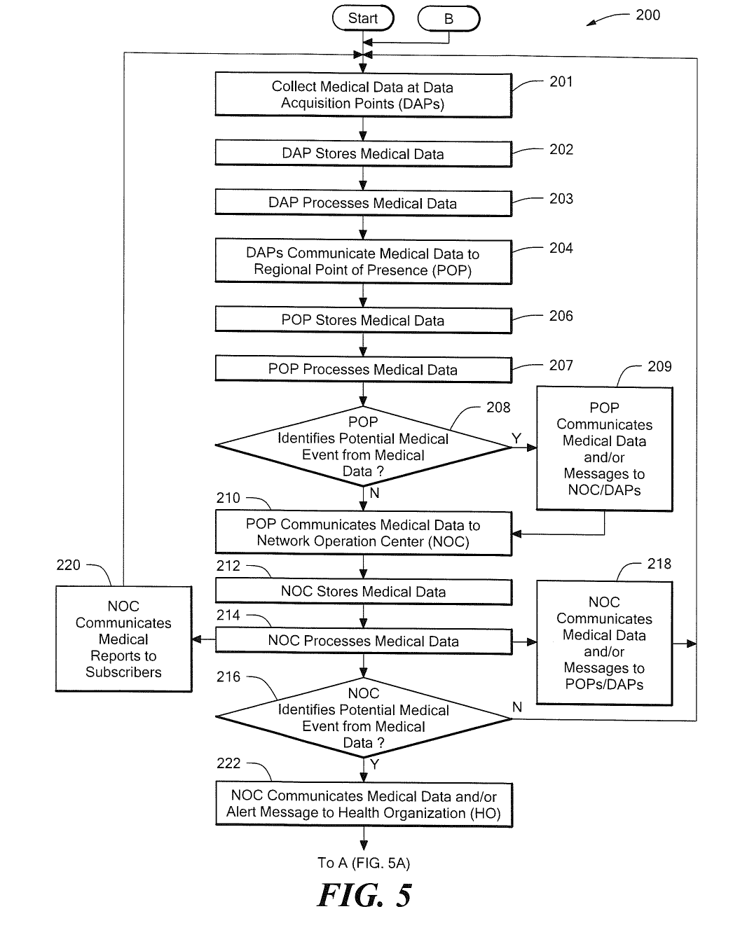

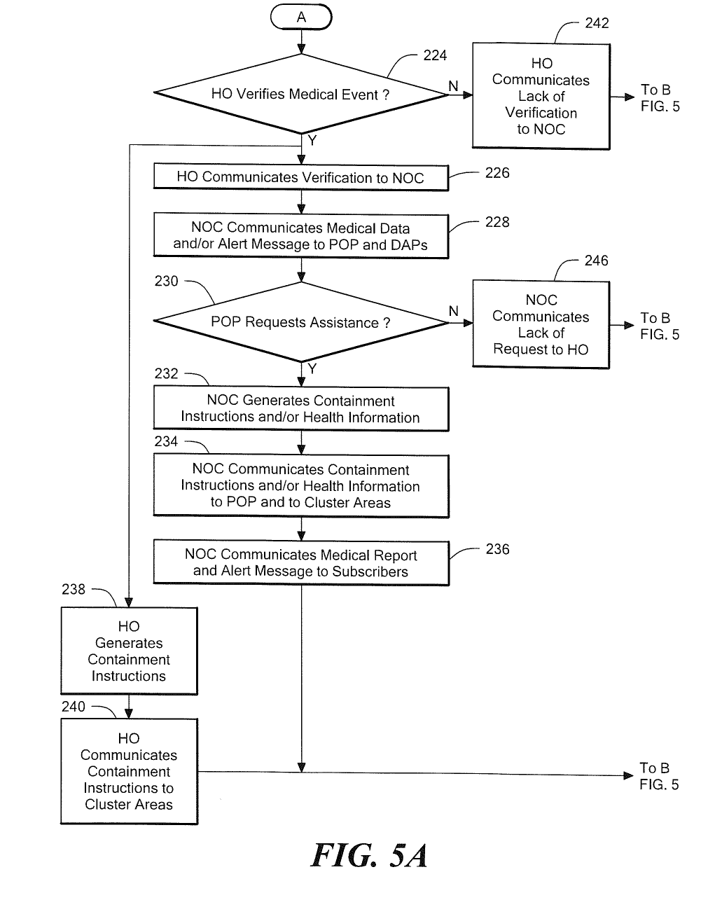

It should be recognized that even without a subscription, for example, by a central health organization 102, the POPs 68, DAPs 62, and other facilities within the country of the central health organization 102 can receive the portions of the NOC processed medical data 78 and one or more of the messages described above, which can include the alert message, by way of the messages 73. Such an arrangement is further described in conjunction with FIG. 5.

The subscribers 100 can receive the messages 95 via security services 96, which can be the same as or similar to the security services 72, and via a communications infrastructure 98, which can be the same as or similar to the communications infrastructure 70.

As described above, the medical data 65aa, 65ab, 65ba, 65bb, 65Na, 64Nb, 67aa, 67ab, 67ba, 67bb, 67Na, 67Nb received by the POPs 68 can be any of the types and formats of medical data shown in FIGS. 2 and 2A. Furthermore, the messages 69a-69N, 95, 73 can be any of the types and formats of medical data shown in FIGS. 2 and 2A. Also, the POP stored medical data 61a-61N, the POP processed medical data 71a-71N, the NOC stored medical data 77, and the NOC processed medical data 78 can be any of the types and formats of medical data shown in FIGS. 2 and 2A. However, in some particular arrangements, the filtered medical records 52a-52d of FIG. 2 are representative of the medical data 65aa, 65ab, 65ba, 65bb, 65Na, 65Nb, 67aa, 67ab, 67ba, 67bb, 67Na, 67Nb received by the POPs 68 and stored as the POP stored medical data 61a-61n. In some particular arrangements, the metadata 56a-56c of FIG. 2A is representative of the POP processed medical data 71a-71N generated by the POPs 68, POP medical data 69a-69N communicated by the POPs 68 to the NOC 74 and of the NOC stored medical data 77. Furthermore, in some particular arrangements, a subset of the metadata 56a-56c of FIG. 2A is representative of the NOC processed medical data 78 generated by the NOC 74. In some particular arrangements, the messages 95 include the above described reports and statistics and, in some arrangements, the messages 73 include record IDs associated with medical data that has been identified to be associated with a medical event.

In some arrangements, the medical data transported amongst the DAPs 62, the POPs 68, and the NOC 74 is substantially transparent. In other words, medical data received or processed by any of the DAPs 62, the POPs 68, or the NOC 74 can be included within (or at least associated record IDs can be included within) the various messages sent about the system 74 to other ones of the DAPs 62, the POPs 68, or the NOC 74. In particular, with this arrangement, a message (e.g., medical data messages and/or an alert message) generated by any particular one of the POPs 68 can be sent both to the NOC 74 and to the DAPs coupled to the particular POP. Similarly, messages generated by the NOC (e.g., medical data messages in the form of reports and statistics and/or an alert message) can be sent to one or more of the subscribers 100 and messages generated by the NOC (e.g., medical data messages in the form of record IDs and/or an alert message) can be sent to one or more of the POPs 68 and to one or more of the DAPs 62 via the POPs 68.

It will become apparent from discussion below in conjunction with FIG. 4 that the POPs 68 can have many or all of the services and features shown within the NOC 74.

Referring now to FIG. 4, system 120 includes DAPs 122, 160 coupled to a POP 140, which is coupled to a NOC 178, which is coupled to subscribers 192. In some arrangements, as described above in conjunction with FIG. 3, the NOC 178 is also coupled to receive a variety of information 194, for example, medical data from one or more existing health networks an/or RHOIs.

The DAPs 122, 160 can be the same as or similar to the DAPS 62 of FIG. 3. Here however, the DAPs are shown in greater detail. Taking one DAP as representative of the other DAPs, a particular DAP is comprised of a terminal (not shown) and a processor 128a (e.g., a computer) having data 130a, 131 a therein. The processor 128a can receive and process DAP stored medical data 130a to generate DAP processed medical data 131a. In some embodiments, the medical records 50a-50d of FIG. 2 are representative of the DAP stored medical data 130a. In some embodiments, the filtered medical records 52a-52d of FIG. 2 are representative or the DAP processed medical data 131a.

The POP 140 can be the same as or similar to one of the POPs 68 of FIG. 3. The POP 140 can include a system control service 142 and also system services 148, POP stored medical data 144, and POP processed medical data 146 coupled to the system control service 142. As described above, the POP 140 is coupled to receive DAP medical data 138 from one or more health clinics 128a-128N and medical data 147 from one or more veterinarian clinics 168a-168M. In some embodiments, the filtered medical records 52a-52d of FIG. 2 are representative of the POP stored medical data 144. In some embodiments, the metadata 56a-56c of FIG. 2A is representative or the POP processed medical data 146.

The POP 140 is coupled via a communication network 172 and via security service 174 to provide POP medical data 176 to the NOC 178. The NOC 178 can include a system control service 180 and also system services 186, NOC stored medical data 182, and NOC processed medical data 184 coupled to the system control service 180.

The system control services 142, 180 can each be the same as or similar to the system control service 76 of FIG. 3, the system services 148, 186 can each be the same as or similar to some or all of the services 80-94 of FIG. 3, the NOC stored medical data 182 can be the same as or similar to the NOC stored medical data 77 of FIG. 3, the NOC processed medical data 184 can be the same as or similar to the NOC processed medical data 78 of FIG. 3, the POP stored medical data 144 can be the same as or similar to the POP stored medical data 61a of FIG. 3, and the POP processed medical data 146 can be the same as or similar to the POP processed medical data 71a of FIG. 3.

With this arrangement, it should be understood that the POPs (e.g., POP 140) and the NOC 178 can perform similar functions and similar processing of medical data. In particular, both the POP 140 and the NOC 178 can be capable of identifying a medical event. However, the NOC 178 can receive and process medical data from a wider range of geographic regions than any one POP. Furthermore, the NOC 178 can generate the above described reports and statistics that are communicated to the subscribers 192.

In some alternate arrangements, there is no NOC 178, and the POPs (e.g., the POP 140) communicate directly with the subscribers 192. In some arrangements, there are no POPs and the DAPs 122, 160 communicate directly with the NOC 178.

It should be appreciated that FIG. 5 together with FIG. 5A are a flowchart showing a process corresponding to the below contemplated technique which would be implemented in system 60 (FIG. 3). Rectangular elements (typified by element 202 in FIG. 5), herein denoted “processing blocks,” represent computer software instructions or groups of instructions. Diamond shaped elements (typified by element 216 in FIG. 5), herein denoted “decision blocks,” represent computer software instructions, or groups of instructions, which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the invention. Thus, unless otherwise stated the blocks described below are unordered meaning that, when possible, the steps can be performed in any convenient or desirable order.

Referring to FIGS. 5 and 5A, an exemplary method 200 begins at block 201 at which medical data is collected (i.e., entered) at one or more DAPs, for example, at the DAPs 62 of FIG. 3. The medical data collected at the DAPs can be any of the medical data types described in conjunction with FIGS. 2 and 2A. In one particular embodiment, the medical data collected at the DAPs is in the form of medical records typified by the medical records 50a-50d of FIG. 2. The medical data collected at the DAPs can be entered by doctors or staff at a clinic, for example, one or more of the clinics 62 of FIG. 3.

At block 202, the DAPs store the medical data and at block 203, the DAPs process the medical data to generate, for example medical data in the form of filtered medical records 52a-52d of FIG. 2.

At block 204, the DAPs communicate medical data to one or more POPs, for example, to the POPs 68 of FIG. 3. The medical data communicated by the DAPs can be any of the medical data types described in conjunction with FIGS. 2 and 2A. In one particular embodiment, the medical data communicated by the DAPs to the POPs is in the form of filtered medical records typified by the filtered medical records 52a-52d of FIG. 2.

At block 206, the POPs optionally store the medical data received from the DAPs and at block 208, the POPs process the medical data received from the DAPs to generate POP processed medical data. In one particular embodiment, the POP processed medical data within the POPs in the form of metadata typified by the metadata 56a-56c of FIG. 2A. The POP processed medical data can optionally also be stored at the POPs in place of or in addition to the medical data received directly from the DAPs.

At block 208, the POP can identify a medical event from within the POP processed medical data as part of the processing performed at block 207. If the POP does not identify a medical event at block 208, the process continues to block 210.

At block 210, the POPs communicate medical data to at least one NOC, for example, to the NOC 74 of FIG. 3. The medical data communicated by the POPs to the NOC can be any of the medical data types described in conjunction with FIGS. 2 and 2A. In one particular embodiment, the medical data communicated by the POPs to the NOC is in the form of metadata typified by the metadata 56a-56c of FIG. 2A.

At block 212, the NOC optionally stores the medical data received from the POPs and at block 214, the NOC processes the medical data received from the POPs to generate NOC processed medical data, which can be different than the POP processed medical data generated at the POPs. The NOC processed medical data can optionally also be stored at the NOC in place of or in addition to the medical data received directly from the POPs.

At block 216, the NOC identifies a potential (unverified) medical event from within the NOC processed medical data as part of the processing performed at block 214.

If a potential medical event is identified by the NOC, at block 222, the NOC communicates at least one of NOC medical data or an alert message to a health organization (HO) for verification. In some embodiments, the health organization is a globally central health organization, for example, the World Health Organization (WHO). The medical data communicated by the NOC to the health organization can be any of the medical data types described in conjunction with FIGS. 2 and 2A. In one particular embodiment, the NOC medical data communicated by the NOC to the HO is in the form of the above-described reports and statistics. However, in other embodiments, the NOC medical data communicated by the NOC to the HO is in the form of metadata (e.g., 56a-56c of FIG. 2A).

At block 224, the health organization verifies the medical event. The verification can include, but is not limited to, re-processing the NOC medical data communicated by the NOC to the HO. The verification can also include a variety of manual steps, including, but not limited to telephone calls from the HO to selected people or organizations at the geographic region at which the NOC has identified the medical event.

If at block 224, the HO verifies the medical event, then the process continues to block 226, where the HO communicates the verification back to the NOC.

At block 228, having received the verification from the HO, the NOC communicates messages back to the POPs and to the DAPs via the POPs. The messages can include NOC medical data indicative of the medical event and an alert message indicative of the medical event. The NOC medical data communicated by the NOC to the POPs can be any of the medical data types described in conjunction with FIGS. 2 and 2A. In one particular embodiment, the NOC medical data communicated by the NOC to the POPs is in the form of record IDs (see e.g., FIGS. 2-2A) associated with a medical event, or alternatively, in the form of metadata associated with the medical event and typified by the metadata 56a-56c of FIG. 2A. The POP medical data communicated by the POPs to the DAPs can also be any of the medical data types described in conjunction with FIGS. 2 and 2A. In one particular embodiment, the POP medical data communicated by the POPs to the DAPS is in the form of record IDs (see e.g., FIGS. 2-2A) associated with a medical event, or alternatively, in the form of metadata associated with the medical event and typified by the metadata 56a-56c of FIG. 2A.

At block 230, a POP can request assistance from the NOC. Accordingly, at block 232, the NOC can generate containment instructions and/or health information in accordance with the services 80-94 described above in conjunction with FIG. 3 and at block 234, the NOC can communicate the containment instructions and/or health information to the POP that requested assistance at block 230.

At block 236, the NOC can communicate medical reports and statistics to its subscribers. The medical reports and statistics, which are described more fully above, can include information in any format, but generally alerts the subscribers to the existence, nature, and geographic extent of the medical event.

At block 224, once the HO verifies the medical event, the HO can also take actions, including, at block 238, generating its own containment instructions, and at block 240, communicating the containment instructions, the disease, and/or identification of the medical event to cluster areas.

At block 230, if there is no request for assistance from a POP, then at block 246, the NOC can communicate the lack of request to the HO.

At block 224, if the HO identifies that the potential medical event is false, then, at block 242, the HO communicates the lack of verification back to the NOC.

At block 216, if the NOC does not identify a potential medical event from the medical data the process 200 returns to the beginning.

At block 208, if the POP does identify a medical event from the medical data processed at block 207, then at block 209 the POP communicates medical data (e.g., record IDs associated with the medical event) to the NOC and/or to the DAPs. The POP can also communicate an alert message to the NOC and/or to the DAPs.

At block 214, as the NOC processes the medical data, at block 220, the NOC can generate routine medical reports at regular intervals, for example once a week, and communicate them to its subscribers. At block 218, the NOC can also communicate routine medical data and/or messages back to the POPs and to the DAPs via the POP at regular intervals, for example, once an hour.

The process 200 can return to the beginning from blocks 216, 218, 220, 236, 240, 242, and 246. In this way, the process continually loops, continually analyzing medical data, which is continually gathered at block 202.

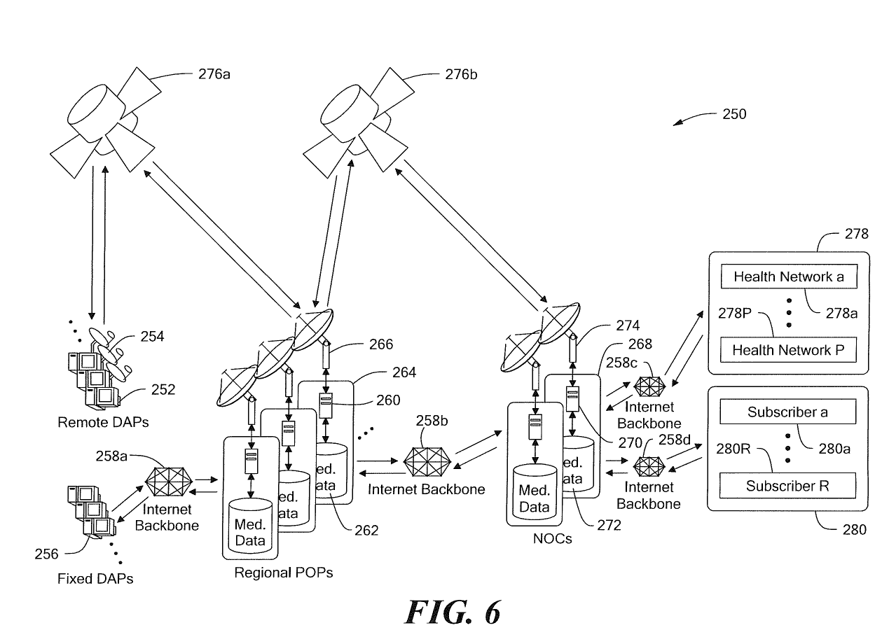

Referring now to FIG. 6, a system 250 can be the same as or similar to the system 60 of FIG. 3. Here, wireless links between antennas 254, 266, 274 and satellite 276a, 276b can provide a global network, even to relatively remote global regions.

Points of presence, e.g., a point of presence 264, can be the same as or similar to one of the POPs 68 FIG. 3. Network operation centers, e.g., a network operation center 268 can be the same as or similar to the NOC 74 of FIG. 3. Subscribers 280 can be the same as or similar to the subscribers 100 of FIG. 3.

Health networks 278, which are not explicitly shown in previous figures, but which communicate with the collaboration service 94 of FIG. 3 via information 114, can include, but are not limited to, PoMed, the Global Outbreak Alert and Response Network, and Global Early Warning System and Response.

Referring now to FIG. 7, a system 300 includes a network operations center (NOC) 308, which can be the same as or similar to the NOC 74 of FIG. 3. The NOC 308 can include an environmental event processing service 310, which can be the same as or similar to the environmental event processing service 92 of FIG. 3.

The NOC 308 can receive medical data associated with POPs 306 and DAPs 302 as described above in FIG. 3 and provide medical reports to subscribers 312. However, the NOC 308 can also be coupled to one or more environmental sensors, each configured to detect an environmental event. Platforms associated with the environmental sensors are depicted in FIG. 7, rather than the sensors themselves. Some communications of data are shown coupled to the NOC 308 via a satellite 338. However, any of the indicated communication links can be landline links and/or wireless links.

An aircraft 314 can have therein a virological (or biological, or chemical) sensor configured to detect a virus. The virological sensor in the aircraft 314 can communicate a sensor signal indicative of detection of the virus to the NOC 308.

A ship 316 can have therein a nuclear sensor configured to detect nuclear material. The nuclear sensor in the ship 316 can communicate a sensor signal indicative of detection of the nuclear material to the NOC 308.

A remote DAP 318 can communicate medical data to the NOC 308.

A platform in the environment, depicted as a bird 322, can have therein a sensor configured to detect a virus. The virulogical sensor on the platform 322 can communicate a sensor signal indicative of detection of the virus to the NOC 308.

A cargo advanced automated radiography system (CAARS) 328 can have therein an x-ray sensor configured to detect dangerous items in ship or train cargo. The sensor on the CAARS 328 can communicate a sensor signal indicative of detection of the dangerous material to the NOC 308.

An advanced spectroscopic portal (ASP) 330 can have therein a spectroscopic sensor configured to detect dangerous materials in a truck. The sensor on the ASP 330 can communicate a sensor signal indicative of detection of the dangerous material to the NOC 308.

A platform 336, which can be a train platform or buildings, and which is depicted as buildings 336, can have thereon one or more remote combined or separate biological/chemical/nuclear sensors. The sensors on the platform 336 can communicate a sensor signal indicative of a detection of a biological, chemical, and/or nuclear event to the NOC 308.

The NOC 308 can process the sensor signals in order to verify an environmental event. Information pertaining to the environmental event can be correlated with a detected medical event and provided to subscribers in much the same was as described above by the process 200 of FIG. 5.

It should be apparent that, while certain physical structures are depicted in FIG. 7, similar sensors can be coupled to other types of structures.

All references cited herein are hereby incorporated herein by reference in their entirety. Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A system, comprising:
a first processing center coupled to receive first medical data in a first format, wherein the first processing center includes a computer processor configured to process the first medical data to generate first processed medical data indicative of a medical event, configured to generate an alert message in accordance with the medical event, and configured to communicate to an information destination at least one of the alert message or second medical data in a second format indicative of at least a portion of the first processed medical data.

2. The system of claim 1, further comprising:
at least one second processing center coupled to receive third medical data in a third format from one or more data acquisition points, wherein the at least one second processing center comprised a computer processor configured to process the third medical data to generate second processed medical data indicative of the medical event and configured to communicate to the first processing center the first medical data in the first format, wherein the first medical data is indicative of at least a portion of the second processed medical data.

3. The system of claim 2, wherein the first format, the second format, and the third format are the same formats, and wherein at least one of the first medical data, the second medical data, or the third medical data comprises a different set of medical data from the other medical data.

4. The system of claim 2, wherein at least one of the first format, the second format, or the third format is a different format from the other formats, and wherein at least one of the first medical data, the second medical data, or the third medical data comprises a different set of medical data from the other medical data.

5. The system of claim 2, wherein the information destination is a subscriber to the system.

6. The system of claim 2, wherein the information destination is a health organization.

7. The system of claim 2, wherein the medical event is indicative of one or more incidents of an infectious disease.

8. The system of claim 7, wherein at least one of the first processing center or the at least one second processing center comprises a respective medical data processing service configured to process at least one of the first medical data or the third medical data, respectively, in order to generate a respective at least one of the first processed medical data or the second processed medical data, and configured to correlate at least one of the first processed medical data or the second processed medical data, respectively, to identify the medical event.

9. The system of claim 8, wherein the medical data processing service is further configured to provide at least one of the first medical data, the second medical data, or the third medical data as metadata and wherein the medical data processing service is further configured to provide another at least one of the first medical data, the second medical data, or the third medical data as a medical data report.

10. The system of claim 7, wherein at least one of the first processing center or the at least one second processing center comprises a medical information service configured to receive medical information associated with the medical event, wherein the medical information comprises information about the infectious disease.

11. The system of claim 10, wherein the medical information further comprises medical assistance information indicative of medical assistance that can be provided to a person infected by the infectious disease.

12. The system of claim 7, wherein at least one of the first processing center or the at least one second processing center comprises an alert service configured to automatically generate the alert message in accordance with the medical event.

13. The system of claim 12, wherein at least one of the first processing center or the at least one second processing center further comprises an instruction service configured to automatically generate a response instruction message in accordance with the medical event, wherein at least one of the first processing center or the at least one second processing center is further configured to communicate the response instruction to the information destination or to the one or more data acquisition points, respectively.

14. The system of claim 12, wherein at least one of the first processing center or the at least one second processing center further comprises a response service configured to coordinate a response in accordance with the medical event.

15. The system of claim 7, wherein at least one of the first processing center or the at least one second processing center further comprises a transportation information service configured to provide transportation information, wherein at least one of the first processing center or the at least one second processing center is further configured to con elate the transportation information with at least one of the first processed medical data or the second processed medical data, respectively.

16. The system of claim 7, wherein at least one of the first processing center or the at least one second processing center further comprises a collaboration service configured to provide a collaboration with one or more preexisting health networks or with one or more preexisting regional health information organizations.

17. The system of claim 7, wherein at least one of the first processing center or the at least one second processing center further comprises an event processing service coupled to receive one or more event sensor signals and configured to correlate the one or more event sensor signals with at least one of the first processed medical data or the second processed medical data.

18. A computer-implemented method of coordinating medical data; comprising:
receiving first medical data in a first format at a first processing center;
processing the first medical data at the first processing center in order to generate first processed medical data indicative of a medical event;
generating an alert message in accordance with the medical event; and
communicating to an information destination at least one of the alert message or second medical data in a second format indicative of at least a portion of the first processed medical data.

19. The method of claim 18, further comprising:
receiving third medical data in a third format at at least one second processing center (POP);
processing the third medical data at the at least one second processing center in order to generate second processed medical data indicative of the medical event; and
communicating to the first processing center the first medical data in the first format, wherein the first medical data is indicative of at least a portion of the second processed medical data.

20. The method of claim 19, wherein the first format, the second format, and the third format are the same formats, and wherein at least one of the first medical data, the second medical data, or the third medical data comprises a different set of medical data from the other medical data.

21. The method of claim 19, wherein at least one of the first format, the second format, or the third format is a different format from the other formats, and wherein at least one of the first medical data, the second medical data, or the third medical data comprises a different set of medical data from the other medical data.

22. The method of claim 19, further comprising subscribing to the method resulting in a system subscriber, wherein the information destination is the system subscriber.

23. The method of claim 19, wherein the information destination is a health organization.

24. The method of claim 19, wherein the medical event is indicative of one or more incidents of an infectious disease.

25. The system of claim 24, further comprising:
providing at least one of the first medical data, the second medical data, or the third medical data as metadata and another at least one of the first medical data, the second medical data, or the third medical data as a medical data report.

26. The method of claim 24, wherein the processing comprises:
processing at least one of the first medical data or the third medical data in order to generate a respective at least one of the first processed medical data or the second processed medical data; and
correlating at least one of the first processed medical data or the second processed medical data to identify the medical event.

27. The method of claim 24, further comprising receiving medical information associated with the medical event, wherein the medical information comprises information about the infectious disease.

28. The method of claim 27, wherein the medical information further comprises medical assistance information indicative of medical assistance that can be provided to a person infected by the infectious disease.

29. The method of claim 24, wherein the generating the alert message comprises automatically generating the alert message in accordance with the medical event.

30. The method of claim 29, further comprising:
automatically generating a response instruction message in accordance with the medical event; and
communicating the response instruction to the information destination or to the one or more data acquisition points.

31. The method of claim 29, further comprising coordinating a response in accordance with the medical event.

32. The method of claim 24, further comprising:
providing a transportation service configured to provide transportation information; and
correlating the transportation information with at least one of the first processed medical data or the second processed medical data.

33. The method of claim 24, further comprising:
providing a collaboration service configured to provide a collaboration with one or more preexisting health networks or with one or more preexisting regional health information organizations.

34. The method of claim 24, further comprising:
receiving one or more event sensor signals from a respective one or more event sensors; and
correlating the one or more event sensor signals with at least one of the first processed medical data or the second processed medical data.
